(19) United States
(12) Patent Application Publication
(10) Pub. No.: US 2011/0233348 A1
(43) Pub. Date: Sep. 29, 2011

(54) Bag Support System

(76) Inventor: Chris Andersen, Kenosha, WI (US)

(21) Appl. No.: 12/938,932

(22) Filed: Nov. 3, 2010

Related U.S. Application Data
(60) Provisional application No. 61/318,437, filed on Mar. 29, 2010.

(51) Int. Cl. B65B 67/12; B23P 19/00

(52) U.S. Cl. 248/97; 29/428

(57) ABSTRACT

The present invention is a bag support system designed to universally support plastic shopping bags with integrated loop handles in an upright and open position for re-use as trash bags or receptacles to store and/or sort other materials or components.

### CROSS-REFERENCE TO RELATED APPLICATIONS

This application claims priority to U.S. Provisional Application No. 61/318,437 filed on Mar. 29, 2009.

### FIELD OF INVENTION

The present invention relates to the field of support systems and more particularly to a plastic bag support system for plastic bags with integrated loop handles.

### BRIEF DESCRIPTION OF THE DRAWINGS

FIG. 1 illustrates an exploded view of an exemplary embodiment of a bag support system.

FIG. 2 illustrates a perspective view of an exemplary embodiment of an assembled bag support system.

FIG. 3 illustrates a front view of an exemplary embodiment of a bag support system.

FIG. 4 illustrates a side view of an exemplary embodiment of a bag support system.

FIG. 5 illustrates a perspective view of a bag supported by an exemplary embodiment of a bag support system.

### BACKGROUND

Every year, Americans throw away more than 100 billion plastic bags after they've been used to transport goods home from grocery stores and other retail and commercial establishments. Only 1 percent of plastic bags worldwide and approximately 2 percent in the United States are recycled. The remaining bags are simply discarded.

Plastic bags are not biodegradable. The environmental impact of such ubiquitous use and routine discarding of trash bags has a detrimental environmental impact that is equivalent to dumping nearly 12 million barrels of oil annually.

The negative environmental impact of plastic bags can be substantially reduced by encouraging re-use of plastic bags by consumers and corporations for a variety of functions. For example, items may be sorted, stored, processed and labeled using plastic bags as receptacles. Plastic bags may also be used as trash receptacles in homes, businesses, and vehicles.

To be used effectively for these uses, plastic bags must be stably supported in an open position. Additionally, it is important that the device that supports the plastic bags be lightweight, low cost, and efficiently packaged to be marketed as a consumer impulse item at the point of purchase and to fully encourage environmentally responsible behavior.

Holders for supporting plastic bags in the open position are known in the art. One example of a bag support is illustrated in U.S. Design Pat. No. Des. 428,544 (Moffitt '544). Moffitt '544 illustrates a bag support with a C-shaped frame with a round component positioned at each corner on the top part of the frame. A plastic bag is secured by looping the handle portion of the bag around the round components on each side. The bag support illustrated by Moffitt '544 is not desirable because the C-shaped frame is not stable on uneven or soft surfaces and it is not designed to accommodate a variety of size plastic bags or bags having varying handle sizes and varying handle configurations.

U.S. Pat. No. 6,199,802 (Scheibe '802) and U.S. Pat. No. 6,651,942 (Yardley '942) disclose collapsible devices for supporting a disposable plastic bag. Both Scheibe '802 and Yardley '942 have a ring or hoop that is used to support the mouth of the plastic bag and a plurality of legs to support the ring or hoop above the ground. The use of a ring or hoop is undesirable because when the device is collapsed or dissembled, the curved portions take up more space and are more difficult to package.

Scheibe '802 secures the plastic bag inside the ring using a plurality of clips, while the outside of the hoop taught by Yardley '942 contains a plurality of tabs to engage and retain the bag mouth by friction. Using clips to secure the plastic bag to the ring is not desirable because clips are easily misplaced and may loosen over time making them less effective. The tabs taught by Scheibe '802 are also not desirable because, in order for the tabs to secure the plastic bag, the mouth of the bag must be tightly stretched over the tabs making it difficult to secure bags with larger mouths or bags that do not have perfectly round mouths.

It is desirable to have a bag support system that is capable of accommodating plastic bags with integrated loop handles of varying sizes and with vary size and design of loop handle commonly used by retailers for consumers to transport their goods from their stores.

It is desirable to have a bag support system for bags with integral loop handles that minimizes the amount of space required for storage or transport.

It is desirable to have a bag support system that is sturdy on surfaces that are not perfectly flat.

It is desirable to have a lightweight, durable, easy to assemble and disassemble, and inexpensive support system for positioning a plastic bag with integral loop handles in an upright and open configuration.

It is further desirable to have a bag support system that is collapsible in a way that allows it to be broken down into a bag and sold on a hanging display.

### SUMMARY OF THE INVENTION

The present invention is a bag support system comprised of two upper horizontal engaging members, two lower horizontal engaging members, a plurality of vertical supporting members, and a plurality of horizontal supporting members. The upper and lower horizontal engaging members include a plurality of protruding components that are used to secure the loop handles of a plastic bag with integral loop handles inside the bag support system.

### DETAILED DESCRIPTION OF INVENTION

For the purpose of promoting an understanding of the present invention, references are made in the text to exemplary embodiments of a bag support system, only some of which are described herein. It should be understood that no limitations on the scope of the invention are intended by describing these exemplary embodiments. One of ordinary skill in the art will readily appreciate that alternate but functionally equivalent materials, sizes and configurations may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

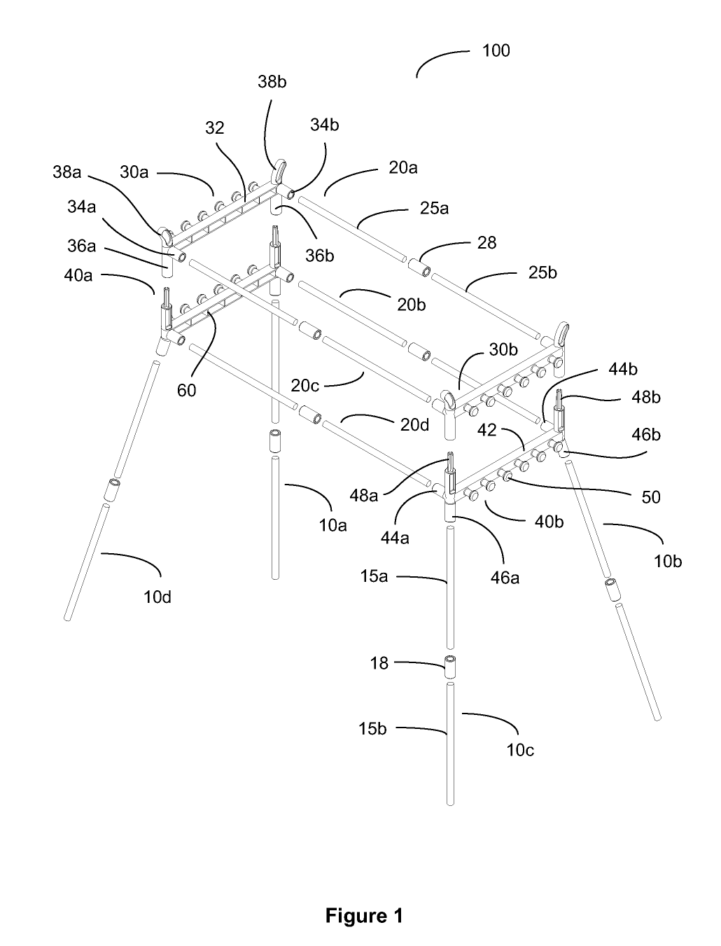

FIG. 1 illustrates an exploded view of an exemplary embodiment of bag support system 100. In the embodiment shown, bag support system 100 is comprised of vertical supporting members 10a, 10b, 10c, 10d, horizontal supporting members 20a, 20b, 20c, 20d, upper horizontal engaging members 30a, 30b, and lower horizontal engaging members 40a, 40b.

In the embodiment shown, vertical supporting members 10a, 10b, 10c, 10d are comprised of tubular members 15a, 15b connected by connector 18 and horizontal supporting members 20a, 20b, 20c, 20d are comprised of tubular members 25a, 25b connected by connector 28. The combining of multiple tubular members 25a, 25b decreases the amount of packaging and space required when bag support system 100 is disassembled for purchase, storage, or transport. In various other embodiments, vertical supporting members 10a, 10b, 10c, 10d and/or horizontal supporting members 20a, 20b, 20c, 20d are comprised of more than two tubular members connected by connectors. In further embodiments, vertical supporting members and horizontal supporting members may be comprised of a single structure.

In the embodiment shown, tubular members 15a, 15b and tubular members 25a, 25b are identical and can be used interchangeably, connectors 18 and connectors 28 are identical and can be used interchangeably. In the embodiment shown, tubular members 15a, 15b, 25a, 25b are tubular shaped with round apertures; however, in other embodiments, tubular members may be square, rectangular or of another shape which facilitates easy assembly and disassembly and is capable of supporting the weight of a bag and its contents.

In an exemplary embodiment, connectors 18, 28 are tubular components separated into two halves by a divider (not visible). To assemble vertical supporting members 10a, 10b, 10c, 10d and horizontal supporting members 20a, 20b, 20c, 20d, one tubular member 15a, 15b, 25a, 25b is inserted into the opening in one end of connector 18, 28 and a second tubular member 15a, 15b, 25a, 25b is inserted into the opening in the other end of connector 18, 28. Tubular members 15a, 15b, 25a, 25b are inserted into connector 18, 28 until the end of tubular member 15a, 15b, 25a, 25b approaches the divider, ensuring that vertical supporting members 10a, 10b, 10c, 10d and horizontal supporting members 20a, 20b, 20c, 20d are correctly assembled.

In the embodiment shown, connectors 18, 28 are approximately 1 inch long with a divider that is approximately 0.063 inches thick and an outer diameter of approximately 0.500 inches. In an exemplary embodiment, the openings of connectors 18, 28 are slightly tapered, with the opening having a slightly larger diameter, facilitating insertion of and engaging the tubular members 15a, 15b, 25a, 25b into connectors 18, 28. For example, the openings of connectors 18, 28 have a diameter of approximately 0.312 inches that tapers to a diameter of approximately 0.296 inches at the divider. In other embodiments, connectors 18, 28 are shorter or longer, have a thinner or thicker divider, and/or have consistent or varying diameters. In various other embodiments, another means for ensuring correct assembly is used such as threading or markings on the tubular members.

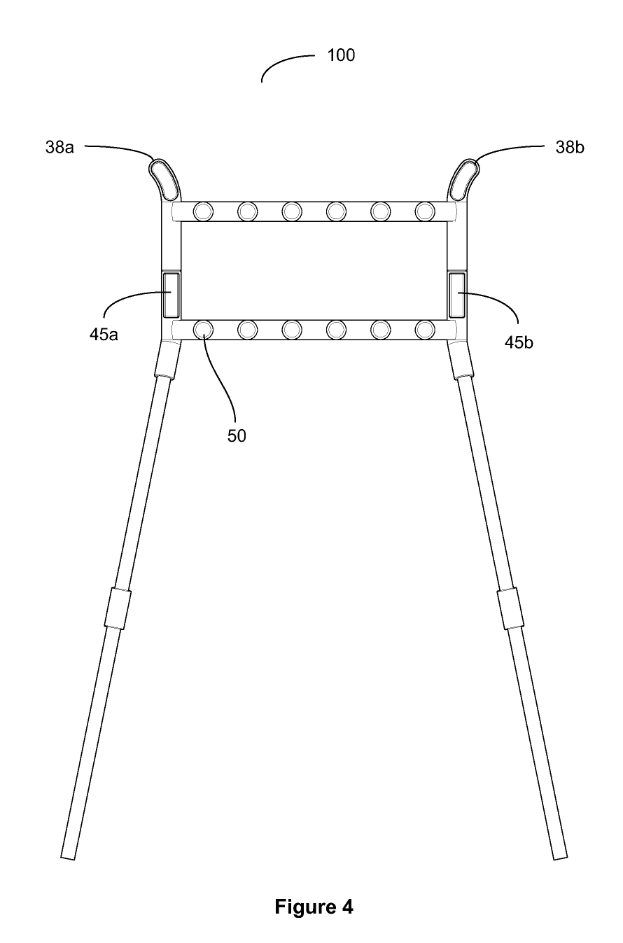

In the embodiment shown, upper horizontal engaging members 30a, 30b are comprised of elongated horizontal portion 32, horizontal connectors 34a, 34b for receiving horizontal supporting members 20a, 20c, vertical connectors 36a, 36b for receiving insertion members 48a, 48b of lower horizontal engaging members 40a, 40b. In the embodiment shown, upper members 38a, 38b are curved and hollow to minimize the weight of upper horizontal engaging members 30a, 30b (see FIG. 4).

In the embodiment shown, lower horizontal engaging members 40a, 40b are comprised of elongated horizontal portion 42, horizontal connectors 44a, 44b for receiving horizontal supporting members 20b, 20d, vertical connectors 46a, 46b for receiving vertical supporting members 10a, 10b, 10c, 10d, and insertion members 48a, 48b. In the embodiment shown, lower horizontal engaging members 40a, 40b further include hollow portion 45a, 45b between elongated horizontal portion 42 and insertion members 48a, 48b to minimize the weight of lower horizontal engaging members 40a, 40b (see FIG. 4).

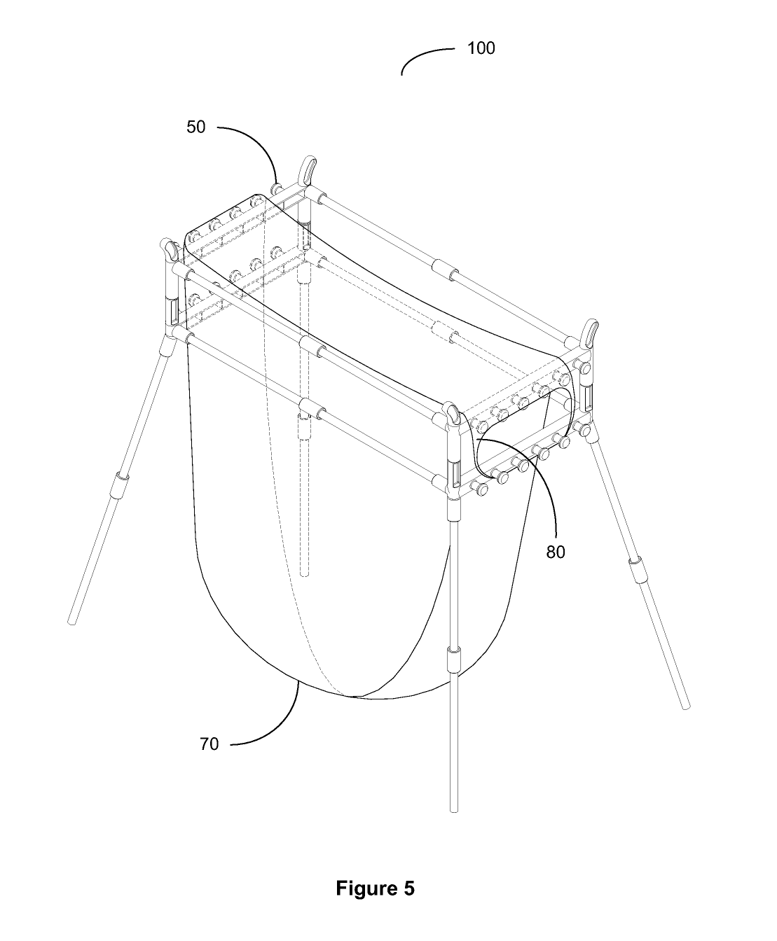

In the embodiment shown, elongated horizontal portions 32, 42 are hollow and have three sides. The side of elongated horizontal portions 32, 42 that faces outward when bag support system 100 is assembled includes a plurality of protruding members 50 for securing the handles of a plastic bag (FIG. 5). The side of elongated horizontal portions 32, 42 that faces inward when bag support system 100 is assembled is open.

In the embodiment shown, elongated horizontal portions 32, 42 have a square cross-section with each of the sides having a width of approximately 0.500 inches. In various embodiments, the dimensions and/or shape of the cross section of elongated horizontal portions 32, 42 may vary. In various embodiments, all four sides of elongated horizontal portions 32, 42 may be enclosed and/or elongated horizontal portions 32, 42 may be solid.

In the embodiment shown, elongated horizontal portions 32, 42 further include a plurality of structural ribs 60 that provide additional support to upper and lower horizontal engaging members 30a, 30b, 40a, 40b while adding minimal weight to bag support system 100. In the embodiment shown, structural ribs 60 are approximately 0.040 inches thick and are spaced approximately 1.070 inches apart. In various embodiments, elongated horizontal portions 32, 42 may include more or fewer structural ribs of varying thicknesses.

In the embodiment shown, protruding members 50 are comprised of a tubular portion having a diameter of approximately 0.313 inches and a larger knob portion having a diameter of approximately 0.500 inches. In the embodiment shown, protruding members extend approximately 0.625 inches outward from elongated horizontal portions 32, 42. In the embodiment shown, each horizontal engaging member 30a, 30b, 40a, 40b has six protruding members 50 spaced approximately 1.125 inches apart. In various other embodiments, elongated horizontal portions 32, 42 may have more or fewer protruding members and/or have differently shaped protruding members, including but not limited to hexagon-shaped, square, triangular, diamond-shaped, polygonal or of another shape that is capable of securing a plastic bag without making it difficult to remove the bag when it is full. In still other embodiments, there are more than two rows of protruding members, the configuration of which may be varied.

To assemble bag support system 100, vertical supporting members 10a, 10b, 10c, 10d and horizontal supporting members 20a, 20b, 20c, 20d are assembled. Insertion members 48a, 48b of lower horizontal engaging members 40a, 40b are then inserted into vertical connectors 36a, 36b of upper horizontal engaging members 30a, 30b. One end of horizontal supporting members 20a, 20b, 20c, 20d is then inserted into horizontal connectors 34a, 34b, 44a, 44b of upper and lower horizontal engaging members 30a, 40a and the second end of horizontal supporting members 20a, 20b, 20c, 20d is inserted into horizontal connectors 34a, 34b, 44a, 44b of upper and lower horizontal engaging members 30b, 40b. One end of vertical supporting members 10a, 10b, 10c, 10d is then inserted into vertical connectors 46a, 46b of lower horizontal engaging members 40a, 40b.

In the embodiment shown, horizontal connectors 34a, 34b, 44a, 44b and vertical connectors 36a, 36b, 46a, 46b have a diameter of approximately 0.500 inches and have slightly tapered openings to facilitate insertion of horizontal supporting members 20a, 20b, 20c, 20d and vertical supporting members 10a, 10b, 10c, 10d, respectively.

In the embodiment shown, vertical connectors 46a, 46b are angled slightly outward causing vertical supporting members 10a, 10b, 10c, 10d to be angled slightly outward, resulting in a bag support system 100 that is sturdy on various uneven or soft surfaces, such as grass and sand.

In the embodiment shown, insertion members 48a, 48b are cross-shaped, slightly tapered, and approximately 1 inch in length. In various embodiments, the shape and/or length may vary. For example, insertion members 48a, 48b may be tubular, triangular, hex-shaped, star-shaped, a slot, or any other shape compatible with the shape of vertical connectors 36a, 36b of upper horizontal engaging members 30a, 30b.

In the embodiment shown in FIG. 1, components are made of plastic, but may be made from any other material known in the art to provide a suitably rigid structure, including, but not limited to, wood and metal.

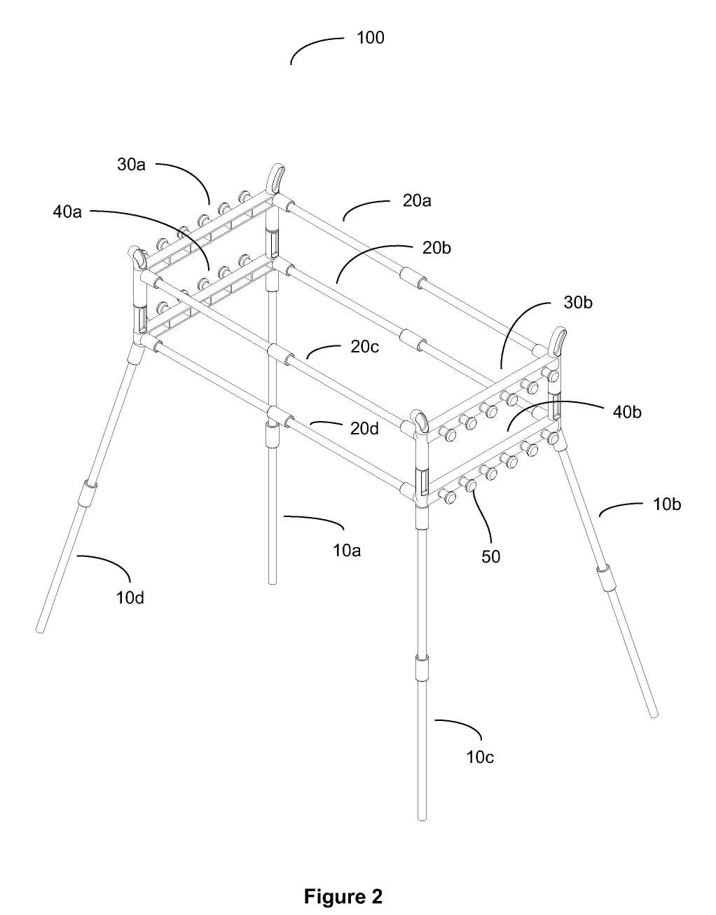

FIG. 2 illustrates a perspective view of an exemplary embodiment of bag support system 100 assembled. In the embodiment shown, when upper and lower horizontal engaging members 30a, 30b, 40a, 40b are connected by horizontal supporting members 20a, 20b, 20c, 20d, a rectangular-shaped frame is formed. In various other embodiments, a square frame may be formed.

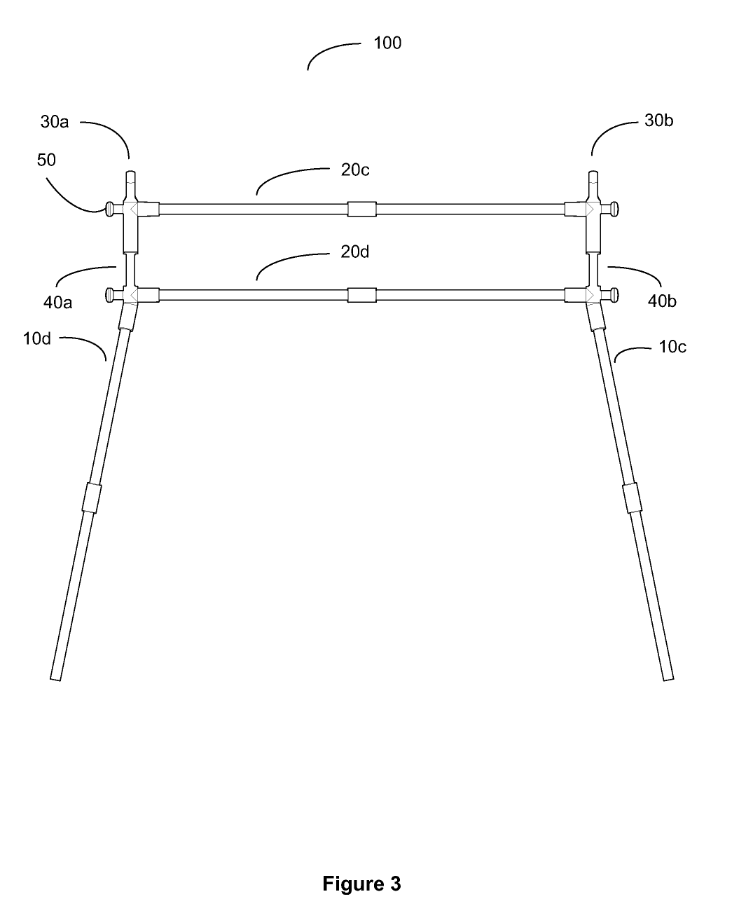

FIG. 3 illustrates a front view of an exemplary embodiment of bag support system 100.

FIG. 4 illustrates a side view of an exemplary embodiment of bag support system 100.

FIG. 5 illustrates a perspective view of a plastic bag 70 supported by an exemplary embodiment of bag support system 100. In the embodiment shown, bag handles 80 are looped around the four middle protruding members 50 on elongated horizontal portion 42 on lower horizontal engaging members 40a, 40b. In various embodiments, bag handles 80 may be looped around more or fewer protruding members 50 and/or may be looped around protruding members 50 on elongated horizontal portions 32 on upper horizontal engaging members 30a, 30b, allowing bag support system 100 to accommodate bags of varying sizes and with varying sizes and styles of loop handles.

In the embodiment shown, when plastic bag 70 is supported by bag support system 100, any logo printed on the bag will be displayed providing additional brand exposure when plastic bags 70 are reused.

What is claimed is:

1. A bag support apparatus comprised of:
a plurality of upper horizontal engaging members comprised of:
an elongated portion having a plurality of protruding members for securing the handles of a plastic bag;
a plurality of horizontal connectors for receiving horizontal supporting members; and
a plurality of vertical connectors for receiving insertion members of lower horizontal engaging members;
a plurality of lower horizontal engaging members comprised of:
an elongated portion having a plurality of protruding members for securing the handles of a plastic bag;
a plurality of horizontal connectors for receiving horizontal supporting members;
a plurality of vertical connectors for receiving vertical supporting members; and
a plurality of insertion members,
a plurality of vertical supporting members; and
a plurality of horizontal supporting members.

2. The apparatus of claim 1 wherein said vertical supporting members and said horizontal supporting members are comprised of two tubular members connected by a connector.

3. The apparatus of claim 2 wherein said connector has a divider and two tapered openings for facilitating insertion of a supporting member.

4. The apparatus of claim 1 wherein said upper horizontal engaging members further includes a plurality of upper members.

5. The apparatus of claim 4 wherein said upper members are hollow.

6. The apparatus of claim 1 wherein said lower horizontal engaging members further include a hollow portion.

7. The apparatus of claim 1 wherein said elongated horizontal portion of said upper horizontal engaging members and said elongated horizontal portion of said lower horizontal engaging members have three sides.

8. The apparatus of claim 7 wherein said elongated horizontal portion of said upper horizontal engaging members and said elongated horizontal portion of said lower horizontal engaging members further include structural ribs.

9. The apparatus of claim 1 wherein said horizontal connectors of said upper horizontal engaging members and said horizontal connectors of said lower horizontal engaging members have tapered openings to facilitate insertion of said horizontal supporting members.

10. The apparatus of claim 1 wherein said vertical connectors of said upper horizontal engaging members and said horizontal connectors of said lower horizontal engaging members have tapered openings to facilitate insertion of said vertical supporting members.

11. The apparatus of claim 1 wherein said vertical connectors of said lower horizontal engaging members are angled outward causing said vertical supporting members to be angle outward.

12. The apparatus of claim 1 wherein said insertion members are cross-shaped.

13. A method for assembling a bag support apparatus comprised of:
assembling a plurality of vertical supporting members and a plurality of horizontal supporting members by inserting a first end of a first tubular member into a first opening of a connector and inserting a first end of a second tubular member into a second opening of said connector;
inserting insertion members of a first lower horizontal engaging member into vertical connectors of a first upper horizontal engaging member;
inserting insertion members of a second lower horizontal engaging member into vertical connectors of a second upper horizontal engaging member;
wherein said first and second upper horizontal engaging members and said first and second lower horizontal engaging members further include a plurality of protruding members;
inserting horizontal supporting members between said first and second upper horizontal engaging members and between said first and second lower horizontal engaging members forming a rectangular-shaped frame;
inserting said vertical supporting members into a plurality of vertical connectors on said first and second lower horizontal engaging members;
looping handles of a plastic bag around said protruding members to secure said plastic bag inside said rectangular-shaped frame.

14. The apparatus of claim 13 wherein said vertical connectors of said first and second lower horizontal engaging members are angled outward causing said vertical supporting members to be angle outward.
